(19) United States
(12) Patent Application Publication
(10) Pub. No.: US 2012/0261124 A1
(43) Pub. Date: Oct. 18, 2012

(54) RECOVERY OF OIL

(75) Inventors: Michael John Crabtree, Tyne & Wear (GB); Philip Fletcher, Cambridgeshire (GB); Jeffrey Forsyth, Inverurie (GB); Guy Mallory Bolton, West Yorkshire (GB)

(73) Assignee: Oilflow Solutions Holding Limited, Lancashire (GB)

(21) Appl. No.: 13/452,281

(22) Filed: Apr. 20, 2012

Related U.S. Application Data
(63) Continuation of application No. 12/311,849, filed on Jul. 6, 2009, now abandoned.

(30) Foreign Application Priority Data
Nov. 1, 2006 (GB) 06216755.0

(51) Int. Cl. C09K 8/88; E21B 43/20; E21B 43/16; B82Y 30/00

(52) U.S. Cl. 166/275; 166/268; 507/230; 977/902

(57) ABSTRACT

A method of recovering oil from a subterranean formation which includes an association production well involves contacting oil in the formation with a treatment fluid formulation which includes polyvinylalcohol and collecting oil which is being contacted with said treatment fluid formulation by said production well. Use of the polyvinylalcohol, optionally in combination with other materials, facilitates recovery of oil from subterranean formation, particularly those involving medium or high viscosity oils.

This invention relates to oil recovery and particularly, although not exclusively, relates to recovery of medium and relatively heavy oils from subterranean formations including bitumen.

It is an ongoing challenge in the oil industry to recover, from subterranean oil-bearing formations, oils which are relatively difficult to recover, such as medium to high viscosity oils, including bitumens, in an economical manner. It is an objective of the present invention to address this problem.

According to a first aspect of the invention, there is provided a method of recovering oil from a subterranean formation which includes an associated production well, the method including the steps of:
(i) contacting oil in said formation with a treatment fluid formulation at a position upstream of said production well, wherein said treatment fluid formulation comprises a polymeric material AA which includes —O— moieties pendent from a polymeric backbone thereof; and
(ii) collecting oil which has been contacted with said treatment fluid formulation via said production well.

The treatment fluid formulation is suitably arranged to enhance the mobility of oil it contacts. It may achieve this by causing a mass of oil to form droplets which are stabilized by said polymeric material. Thus after contact with said treatment fluid formulation, the oil may comprise a dispersion and/or emulsion of oil droplets, suitably in water.

Prior to contact, the formation may include regions of oil which are separated from one another. For example, oil may be trapped in pores or other hollow regions and separated from other oil trapped in pores or other hollow regions. Preferably, in the method, the treatment fluid formulation is arranged to contact (and suitably enhance the mobility of) oil arranged in at least two (preferably a multiplicity—e.g. over a hundred) spaced apart positions. Thus, said treatment fluid formulation is preferably not arranged solely to contact a single large mass of oil within the formation. The oil is preferably not moving along a predetermined, for example man-made, travel path when initially contacted with said treatment fluid formulation.

The method may be used after some oil has been removed from the formation by an alternative method.

In some embodiments, the method may include one step which comprises contacting oil in said formation with said treatment fluid formulation as described and another step which involves contacting the formation with a different formulation. Subsequent to contact with the different formulation, there may be a further step which comprises contacting oil in said formation with treatment fluid formulation as described. The aforementioned sequence of steps may be repeated one or more times. In one embodiment, said different formulation may comprise steam.

Initial contact of oil in said formation with said treatment fluid formulation suitably takes place at a position which is at least 5 m, preferably at least 10 m, more preferably at least 50 m, especially at least 100 m, upstream of said production well although treatment fluid formulation could additionally contact some oil at positions closer to said production well. Initial contact suitably takes place a distance of at least 10 m, preferably at least 20 m below ground level.

Said treatment fluid may travel at least 10 m, preferably at least 20 m before it contacts oil in said formation.

After initial contact with said treatment fluid formulation, oil may travel at least 10 m, preferably at least 20 m, more preferably at least 50 m prior to reaching said production well.

The subterranean formation which comprises oil to be recovered is suitably a naturally occurring porous medium. Said formation may have a permeability of less than 20 Darcy, suitably less than 10 Darcy. The permeability may be at least 2 milliDarcy, preferably at least 4 milliDarcy. In one embodiment the permeability may be in the range 5-20 milliDarcy; in another embodiment it may be in the range 0.1 to 10 Darcy, preferably 2 to 6 Darcy.

Before contact with said treatment fluid formulation, the oil in said formation may have a viscosity of at least 100 cP, suitably at least 250 cP, preferably at least 500 cP, when measured at the reservoir temperature of the oil and at a shear rate of 100 s⁻¹. This viscosity may be as high as 200,000 cP or even 10,000,000.

Before contact with said treatment fluid formulation, the oil in said formation may have a viscosity, measured at 25° C. and a shear rate of 100 s⁻¹, of at least 100 cP, suitably at least 200 cP, preferably at least 400 cP, more preferably at least 800 cP, especially at least 1200 cP. In some cases, the viscosity may be greater than 5000 cP, or even 50,000 cP.

The aforementioned viscosities (and other viscosities described herein unless otherwise stated) may be measured using an Anton PAAR MCR 300 rheometer equipped with cone and plate sensors.

Said treatment fluid formulation may be introduced into the formation at a pressure of at least 100 Psi. The pressure is preferably less than 20,000 Psi.

Said treatment fluid formulation may be at a temperature of at least ambient temperature immediately prior to introduction into the formation. Preferably, the temperature is above ambient temperature immediately prior to said introduction. It may be at least 5° C., preferably at least 10° C. above ambient temperature. The ratio of the temperature immediately prior to introduction compared to the reservoir temperature at the position of introduction may be at least 0.5, preferably at least 0.7, more preferably at least 0.9. Preferably, the temperature of the treatment fluid immediately prior to introduction is approximately the same as the reservoir temperature at the position of initial contact with said treatment fluid formulation. Preferably, said treatment fluid has a temperature in the range 1 to 200° C., preferably 1 to 100° C., immediately prior to said introduction.

Said treatment fluid formulation may be introduced into the formation at a rate of at least 0.5 l·s⁻¹, preferably 0.75 l·s⁻¹, more preferably about 11 l·s⁻¹.

The treatment fluid formulation may be introduced into the formation substantially continuously over a period of at least 1 hour, preferably 12 hours, more preferably 1 day, especially at least 1 week.

The method preferably involves introducing said treatment fluid formulation into said formation via an injection well. In some embodiments, treatment fluid may be introduced into a plurality, suitably three or more, injection wells, suitably substantially concurrently.

Said injection well may be selected from a vertical well, a deviated well or a horizontal well.

Preferably, initial contact of oil in said formation by said treatment fluid formulation causes oil to move in a first direction, wherein suitably the oil contacted was not moving in said first direction prior to said initial contact. Preferably, initial contact of oil in said formation causes the speed of movement of the oil contacted to increase. For example, the oil may be trapped and therefore substantially stationary (except for molecular motion of the oil) prior to contact. After contact, oil may be caused to move and so its speed will be increased. Suitably after contact, oil travels substantially at the speed of the treatment fluid formulation with which it is associated. In some cases, gravity may act on the oil to move it towards the production well in which case oil may move to the production well under both gravity and the force applied by said treatment fluid formulation. In other embodiments, substantially the only force causing oil to move towards the production well may be supplied by said treatment fluid formulation.

Preferably, the treatment fluid is arranged (e.g. by virtue of the pressure applied to it to introduce it into the formation) to carry oil towards the production well.

The subterranean formation may include a plurality of production wells via which oil which has been contacted with said treatment fluid formulation may be collected.

A said production well may be selected from a vertical well, a deviated well, a horizontal well, a multilateral well and a branched well.

Preferably, the viscosity of the treatment fluid formulation is not arranged to increase (except due to a temperature change of the treatment fluid formulation or the treatment fluid formulation becoming associated with oil) during passage of the treatment fluid formulation through the formation. Preferably, the treatment fluid formulation does not form a gel during passage through the formation. Preferably, no means (e.g. chemical) is introduced into the formation to cause the treatment fluid formulation to cross-link and/or form a gel during passage through the formation. Preferably, no component of the treatment fluid formulation cross-links during passage through the formation. Preferably no covalent bonds are formed between molecules in the treatment fluid formulation during passage through the formation.

The material collected in step (ii) suitably comprises oil and said treatment fluid formulation. The respective amounts of oil and treatment fluid formulation in the material collected will vary over time. Initially, the material collected may include relatively large volumes of oil; subsequently as oil is recovered from the formation its proportion in the treatment fluid formulation may be reduced. At some stage in the method, the material collected suitably includes greater than 5 wt %, preferably greater than 10 wt %, more preferably greater than 20 wt %, especially greater than 30 wt % of oil.

The material collected in step (ii) may comprise less than 1 wt %, or even less than 0.75 wt % of said polymeric material AA.

The material collected in step (ii) may comprise greater than 30 wt %, greater than 40 wt % or greater than 50 wt % of water.

The method may include the step of causing oil to separate from at least part of the treatment fluid formulation after collection in step (ii).

In one embodiment, material collected via said production well may be transported, for example via a pipeline, to a desired location prior to separation.

Said treatment fluid formulation suitably has a viscosity at 25° C. and 100 s⁻¹ of greater than 0.5 cP, suitably greater than 1 cP, preferably greater than 1.2 cP, especially greater than 1.5 cP. Said treatment fluid formulation preferably has a viscosity under the conditions described of not greater than 10 cP, preferably of 5 cP or less, more preferably of 2 cP or less.

Preferably, after contact between said treatment fluid formulation and said oil, a mixture is formed which exhibits shear thinning behaviour.

Said treatment fluid formulation may include at least 70 wt %, preferably at least 80 wt %, more preferably at least 85 wt %, especially at least 95 wt % water. The amount of water may be less than 99.8 wt %, preferably less than 99.6 wt %. Said treatment fluid formulation preferably includes 90 to 99.8 wt % water, more preferably 95 to 99.8 wt % water, especially, 98 to 99.8 wt % water.

Said treatment fluid formulation suitably includes at least 0.2 wt %, preferably at least 0.3 wt %, especially at least 0.4 wt % of said polymeric material AA. Said formulation suitably includes less than 5 wt %, preferably less than 3 wt %, more preferably less than 2 wt %, especially less than 1 wt % of said polymeric material AA.

In a preferred embodiment, said treatment fluid formulation includes 98.0 to 99.6 wt % water and 0.4 to 2.0 wt % of said polymeric material AA.

Water for use in the treatment fluid formulation may be derived from any convenient source. It may be potable water, surface water, sea water, aquifer water, deionised production water and filtered water derived from any of the aforementioned sources. Said water is preferably a brine, for example sea water or is derived from a brine such as sea water. The references to the amounts of water herein suitably refer to water inclusive of its components, e.g. naturally occurring additives such as found in sea water.

The total amount of active materials (e.g. materials arranged to facilitate passage of oil to the production well) in said treatment fluid formulation is preferably at least 0.2 wt %, preferably at least 0.3 wt %, especially at least 0.4 wt %. Said total amount in said formulation is suitably less than 5 wt %, preferably less than 3 wt %, more preferably less than 2 wt %, especially less than 1 wt %.

Where said treatment fluid formulation includes one or more additional materials in addition to said polymeric material AA and water, said one or more additional materials may be arranged to be surface active, affect the pH of the formulation or comprise an insoluble particle arranged to increase turbulence within the treatment fluid formulation.

Where said treatment fluid formulation includes one or more materials in addition to said polymeric material AA and water, said treatment fluid formulation may include one or more materials selected from water soluble silicates, nano particles, soluble gases, pH modifiers, surfactants and insoluble liquid hydrocarbon which may optionally be emulsified.

Said treatment fluid formulation may include a means for increasing turbulence within the treatment fluid formulation. Such a means may comprise asymmetrical particles, preferably asymmetrical nanoparticles. After introduction, for example injection, of the treatment fluid formulation including asymmetrical particles, into the formation, the particles will initially be carried predominantly down the central and fastest streamline. In view of the asymmetry of the particles and the velocity distribution of the fluid streamlines, the particles will migrate outwardly to the surfaces of pore throats and channels defined in the subterranean formation. As a result, at the outer edges of the fluid flow, the particles will agitate oil trapped at a formation interface by a combination of direct contact, attrition and an indirect vortex effect. In this regard, as the particles rotate, vortices propagate to the edges of the limbs. As the limbs are forced back into higher velocity flow lines, the vortices “snap” off, leaving the free vortices to agitate the oil surface.

The inclusion of asymmetrical particles in the treatment fluid formulation may provide a means whereby a fluid flowing in a first direction also has a component lateral or transverse to the first direction and such additional component may facilitate removal of oil from a difficult to access sand/rock and oil interface.

Typically pore throats which may contain oil which is difficult to recover may have average diameters in the range 2 μm to 60 μm. The permeability of the formation may be in the range 20 milliDarcy to 22 Darcy, preferably 100 milliDarcy to 10 Darcy, more preferably 500 milliDarcy to 5 Darcy. The formation is preferably consolidated but need not be so.

The particle sizes are preferably selected so they have diameters which are on average less than one-eighth of the diameters of the pore throats. The particles may have largest dimensions in the range 50 nm to 5000 nm, preferably 80 nm to 300 nm, more preferably 100 nm to 250 nm.

The particles are preferably rigid, since this may optimise their effectiveness.

The particles are suitably nano-particles as described. Such particles may be composed of self-assembling polymers, or comprise carbon or silica based nano-particles.

Said treatment fluid formulation may include 10 ppm to 1000 ppm of said particles, where “ppm” refers to parts per million by weight.

Said means for increasing turbulence and/or asymmetrical particles may be of utility in treatment fluid formulations of different types to those described above. The invention therefore extends to a method of recovering oil from a subterranean formation which includes an associated production well, the method comprising

(a) contacting oil in said formation with a treatment fluid formulation at a position upstream of the production well, wherein said treatment fluid formulation includes a means for increasing turbulence as described;
(b) collecting oil which has been contacted with said treatment fluid formulation via said production well.

Suitably, said polymeric material AA makes up at least 90 wt %, preferably at least 95 wt %, more preferably at least 98 wt %, especially at least 99 wt % of active materials in said treatment fluid formulation. In the most preferred embodiment, preferably substantially the only, active material (e.g. surface active material) in said treatment fluid formulation is polymeric material AA.

Said polymeric material AA is preferably soluble in water at 25° C. Preferably, polymeric material AA in said treatment fluid formulation is wholly or partially dissolved therein to define a solution or dispersion.

Whilst the applicant does not wish to be bound by any theory, said polymeric material AA may be arranged to adsorb onto the surface of particles of oil, whereby the coated particles may be hindered from agglomerating. Said polymeric material AA is preferably not a conventional surfactant having a hydrophobic portion, for example a hydrophobic tail and a hydrophilic portion, for example an ionic head. Thus, it is believed that formation of said coated particles preferably does not involve a hydrophobic tail part interacting with oil and a hydrophilic part interacting with, for example water.

Said polymeric backbone of polymeric material AA preferably includes carbon atoms. Said carbon atoms are preferably part of —CH₂— moieties. Preferably, a repeat unit of said polymeric backbone includes carbon to carbon bonds, preferably C—C single bonds. Preferably, said polymeric material AA includes a repeat unit which includes a —CH₂— moiety. Preferably, said polymeric backbone does not include any —O— moieties, for examples —C—O— moieties such as are found in an alkyleneoxy polymer, such as polyethyleneglycol. Said polymeric backbone is preferably not defined by an aromatic moiety such as a phenyl moiety such as is found in polyethersulphones. Said polymeric backbone preferably does not include any —S— moieties. Said polymeric backbone preferably does not include any nitrogen atoms. Said polymeric backbone preferably consists essentially of carbon atoms, preferably in the form of C—C single bonds.

Said treatment fluid formulation may comprise a polyvinylalcohol or polyvinylacetate.

Said —O— moieties are preferably directly bonded to the polymeric backbone.

Said polymeric material AA preferably includes, on average, at least 10, more preferably at least 50, —O— moieties pendent from the polymeric backbone thereof. Said —O— moieties are preferably a part of a repeat unit of said polymeric material AA.

Preferably, said —O— moieties are directly bonded to a carbon atom in said polymeric backbone of polymeric material AA, suitably so that said polymeric material AA includes a moiety (which is preferably part of a repeat unit) of formula:

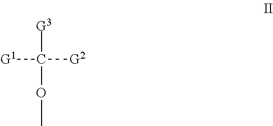

where G¹ and G² are other parts of the polymeric backbone and G³ is another moiety pendent from the polymeric backbone. Preferably, G³ represents a hydrogen atom.

Preferably, said polymeric material AA includes a moiety

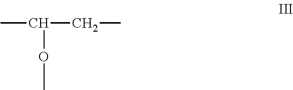

Said moiety III is preferably part of a repeat unit. Said moiety III may be part of a copolymer which includes a repeat unit which includes a moiety of a different type compared to moiety III. Suitably, at least 60 mole %, preferably at least 80 mole %, more preferably at least 90 mole % of polymeric material AA comprises repeat units which comprise (preferably consists of) moieties III. Preferably, said polymeric material AA consists essentially of repeat units which comprise (preferably consist of) moieties III.

Suitably, 60 mole %, preferably 80 mole %, more preferably 90 mole %, especially substantially all of said polymeric material AA comprises vinyl moieties.

Preferably, the free bond to the oxygen atom in the —O— moiety pendent from the polymeric backbone of polymeric material AA (and preferably also in moieties II and III) is bonded to a group R¹⁰ (so that the moiety pendent from the polymeric backbone of polymeric material AA is of formula —O—R¹⁰). Preferably group R¹⁰ comprises fewer than 10, more preferably fewer than 5, especially 3 or fewer carbon atoms. It preferably only includes atoms selected from carbon, hydrogen and oxygen atoms. R¹⁰ is preferably selected from a hydrogen atom and an alkylcarbonyl, especially a methylcarbonyl group. Preferably moiety —O—R¹⁰ in said polymeric material AA is an hydroxyl or acetate group.

Said polymeric material AA may include a plurality, preferably a multiplicity, of functional groups (which incorporate the —O— moieties described) selected from hydroxyl and acetate groups. Said polymeric material preferably includes at least some groups wherein R¹⁰ represents an hydroxyl group. Suitably, at least 30%, preferably at least 50%, especially at least 80% of groups R¹⁰ are hydroxyl groups. Said polymeric material AA preferably includes a multiplicity of hydroxyl groups pendent from said polymeric backbone; and also includes a multiplicity of acetate groups pendent from the polymeric backbone.

The ratio of the number of acetate groups to the number of hydroxyl groups in said polymeric material AA is suitably in the range 0 to 3, is preferably in the range 0.1 to 2, is more preferably in the range 0.1 to 1. The ratio is preferably less than 0.5, more preferably less than 0.4. In especially preferred embodiments, the ratio may be in the range 0.1 to 0.45, is suitably in the range 0.1 to 0.4, is preferably in the range 0.1 to 0.3, is more preferably in the range 0.1 to 0.25, and is especially in the range 0.12 to 0.20.

Preferably, substantially each free bond to the oxygen atoms in —O— moieties pendent from the polymeric backbone in polymeric material AA is of formula —O—R¹⁰ wherein each group —OR¹⁰ is selected from hydroxyl and acetate.

Preferably, said polymeric material AA includes a vinyl alcohol moiety, especially a vinyl alcohol moiety which repeats along the backbone of the polymeric material. Said polymeric material AA preferably includes a vinyl acetate moiety, especially a vinylacetate moiety which repeats along the backbone of the polymeric material.

Polyvinylalcohol is generally made by hydrolysis of polyvinylacetate. Said polymeric material AA may comprise a 0-100% hydrolysed, suitably a 5 to 95% hydrolysed, preferably a 60 to 95%, more preferably a 70 to 95%, especially a 80 to 90%, hydrolysed polyvinylacetate

Said polymeric material AA may have a number average molecular weight (Mn) of at least 10,000, preferably at least 50,000, especially at least 75,000. Mn may be less than 500,000, preferably less than 400,000. Said polymeric material AA is preferably a polyvinyl polymer. Said polymeric material AA may be a copolymer.

Said polymeric material AA is preferably a polyvinyl alcohol polymer or copolymer.

Preferably, said polymeric material AA includes at least one vinyl alcohol/vinyl acetate copolymer which may include greater than 5%, suitably includes greater than 30%, preferably greater than 65%, more preferably greater than 80% of vinyl alcohol moieties.

Said polymeric material AA may be a random or block copolymer.

According to a second aspect of the invention, there is provided the use of a treatment fluid formulation for improving the mobility of oil in a subterranean formation at a position upstream of a production well associated with the formation to facilitate flow of oil from the formation into the production well wherein said treatment fluid formulation comprises a polymeric material AA which includes —O— moieties pendent from a polymeric backbone thereof.

According to a third aspect of the invention, there is provided a subterranean formation which includes an associated production well, the subterranean formation including a treatment fluid formulation at a position upstream of the production well, said treatment fluid formulation comprising a polymeric material AA which includes —O— moieties pendent from a polymeric backbone thereof.

The subterranean formation preferably includes said treatment fluid formulation at a position downstream of an injection well of the subterranean formation.

Said oil particles are preferably stabilised by said polymeric material AA. The subterranean formation preferably includes oil particles dispersed in water. Said oil particles are preferably stabilised by the polymeric material of said treatment fluid formulation. Said subterranean formation may include treatment fluid formulation at a position close to an injection well of the formation and downstream thereof may include a mixture of treatment fluid formulation and oil, suitably with particles of oil being dispersed as aforesaid. Preferably, the concentration of oil in said treatment fluid formulation close to the injection well is less than the concentration of oil in treatment fluid formulation downstream of the injection well. The concentration of oil in said treatment fluid formulation close to the injection well may be less than 5 wt %, preferably less than 1 wt %. It may be substantially zero.

Any feature of any aspect of any invention or embodiment described herein may be combined with any feature of any aspect of any other invention or embodiment described herein mutatis mutandis.

Specific embodiments of the invention will now be described, by way of example, with reference to the accompanying figures in which:

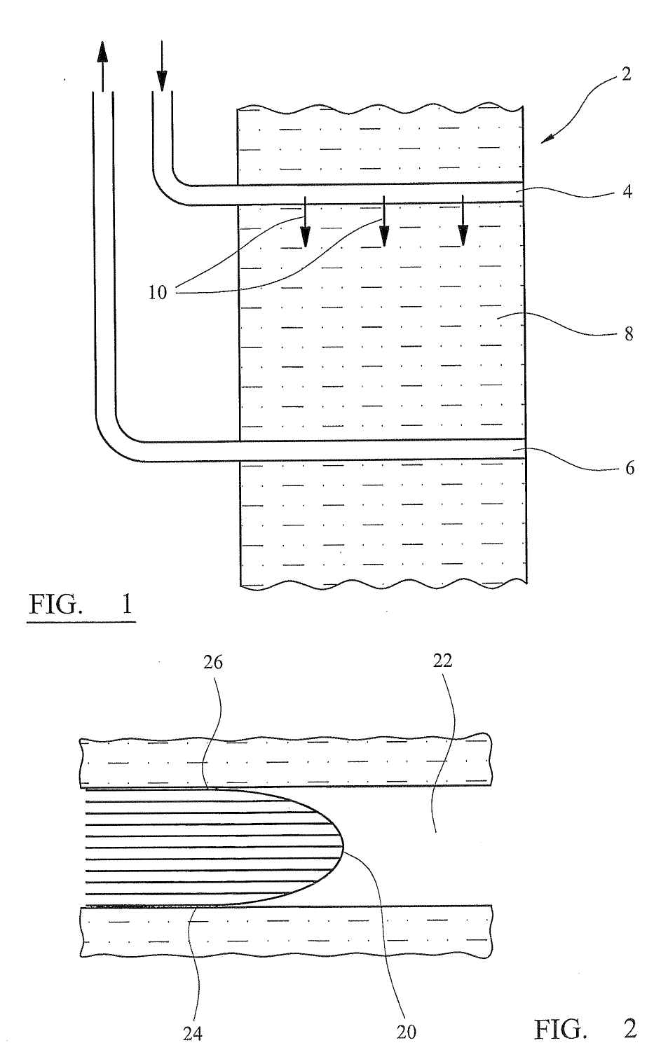

FIG. 1 is a diagrammatic cross-section through a subterranean oil-bearing formation;

FIG. 2 is a diagrammatic representation of treatment fluid moving through a pore in a subterranean oil-bearing formation;

FIG. 3 is a diagrammatic representation of apparatus used to simulate the use of treatment fluid in recovering oil from a subterranean formation;

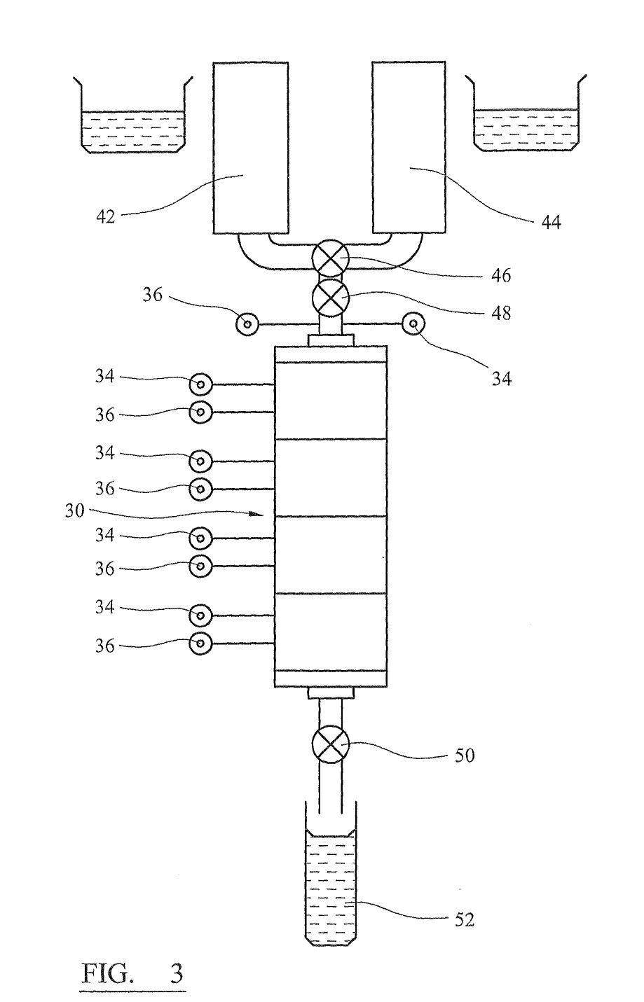

FIGS. 4 to 7 are schematic representations of injection and/or production well types;

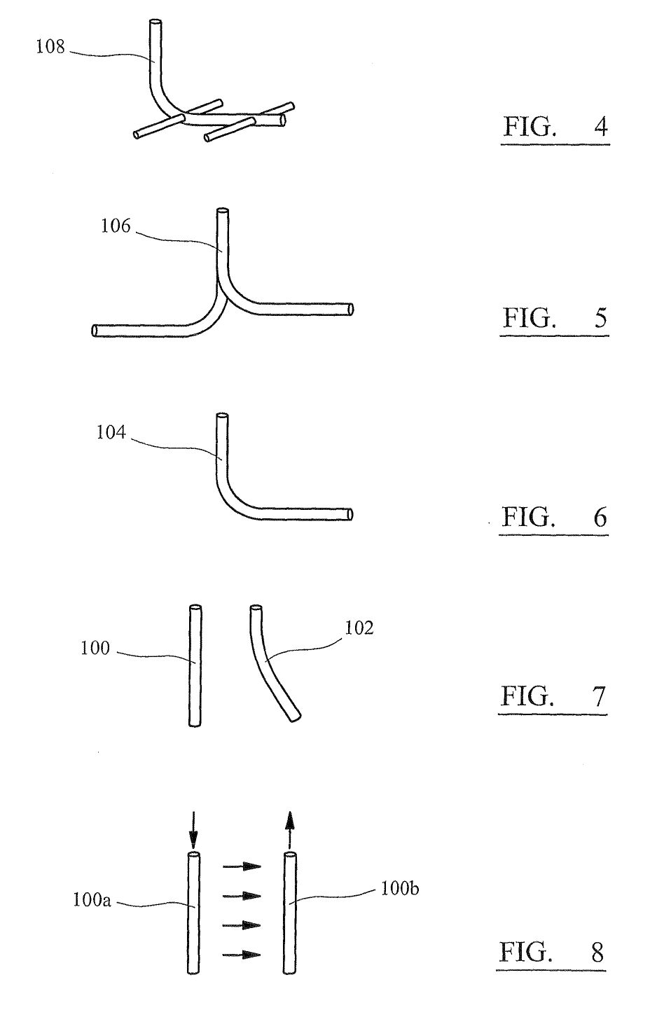

FIGS. 8 to 10 show various injector/producer well combinations;

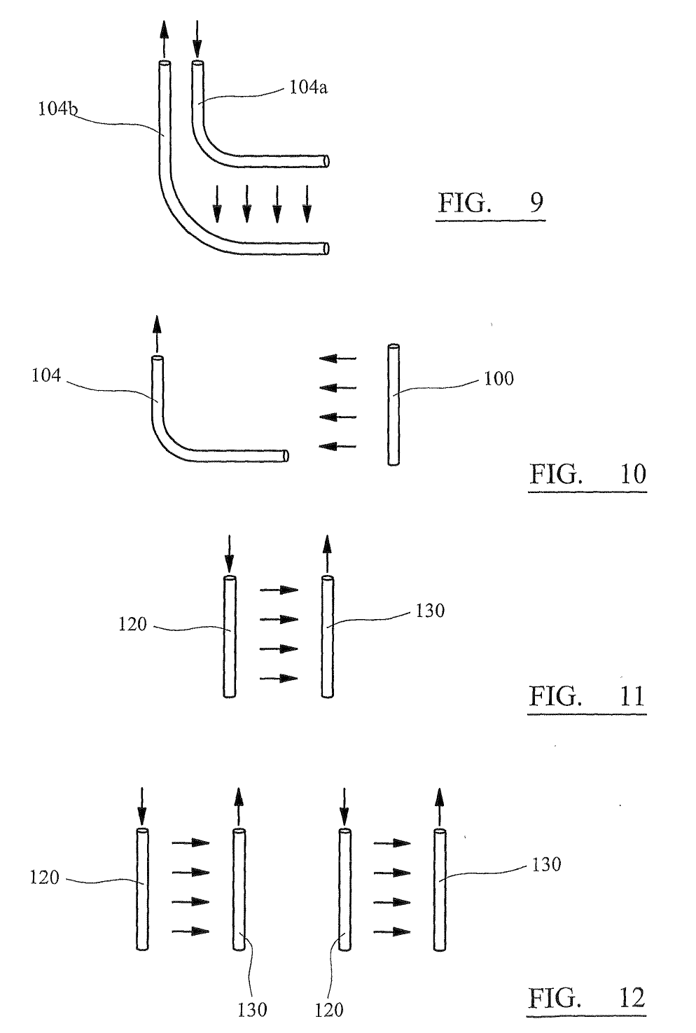

FIGS. 11 and 12 show two heavy oil extraction techniques.

Referring to FIG. 1, a subterranean oil bearing formation 2 includes a horizontal injection well 4 which is vertically spaced from a production well 6 with oil bearing formation 8 extending therebetween. The formation 8 may include medium or heavy oil, for example having a API of less than about 30° and/or a viscosity measured at 25° C. in excess of 1000 cP. The formation 2 may have a permeability of for example 1-6 Darcy.

Oil in the formation 2 may be present in a number of different forms. For example, discrete oil globules may be present in relatively large pores in the rock of the formation. Additionally, oil may be loosely adsorbed on rock surfaces. Also, oil may be present in microcapillaries.

To recover oil from the formation 2, a treatment fluid may be injected into the formation via injection well 4 so that it enters the formation as represented by arrows 10. The treatment fluid comprises a 0.1 to 2 wt % aqueous solution of polyvinylalcohol which may be prepared as described in Example 1 below.

After entering the formation, the treatment fluid will slowly move downwardly under gravity and permeate the formation. As it moves, the formulation is able to strip small amounts of oil from any oil it contacts and disperse and/or emulsify it.

Referring to FIG. 2, treatment fluid 20 is shown flowing through a pore 22 which may have a diameter of the order of 10 μm. The fluid exhibits lamina flow. As a result, the velocity of the fluid is highest along outermost laminars (e.g. 24, 26). So, when the fluid flows past oil, for example adsorbed on a rock surface, it may strip layers of the oil from the surface. Additionally when it passes an oil globule it may strip oil from the globule. Furthermore, as it may contact oil at an opening of a microcapillary, it may strip oil from the microcapillary.

Thus, the treatment fluid may gradually erode areas of oil which it contacts.

Furthermore, the treatment fluid is able to disperse and/or emulsify oil which is eroded/stripped as aforesaid. More particularly, the poly(vinylalcohol) is able to coat particles of the oil, thereby preventing such particles coalescing and allowing them to disperse in water.

Further information and evidence for the mechanism described above is provided in the following examples.

After oil has been contacted with the treatment fluid, the fluidic mixture formed continues to move downwardly under the influence of gravity whereupon the fluid may contact and encapsulate/emulsify further oil it comes into contact with. Eventually, the oil-containing treatment fluid passes into the production well 6 for removal from the formation using standard techniques.

The oil-containing treatment fluid may be transported to a remote location, for example a refinery, via a pipeline. After it has reached its destination, the oil can be separated from the treatment fluid. This may be achieved by simply allowing the oil-containing fluid to stand, whereupon the oil may separate out. Alternatively, the oil may be separated as aforesaid close to the production well. In this case, it may be possible to re-use the treatment fluid in the recovery of further oil from the formation 2.

Example 1 below describes the preparation of a treatment fluid. Example 2 describes a simple experiment to illustrate the erosion/stripping of oil by the treatment fluid as described above. Example 3 simulates oil recovery.

### EXAMPLE 1

### Preparation of Treatment Fluid

A 10 wt % poly(vinylalcohol) solution was prepared by slowly stirring a known amount of water and adding a known amount of 88% hydrolysed poly(vinylalcohol) of molecular weight 180,000 to the stirred water. The suspension was stirred for 1 hour and, thereafter, the suspension was heated at a temperature of 60° C. until the suspended particles dissolved and the solution was clear. The solution was then allowed to cool to less than 5° C. and maintained at this temperature until used.

0.5 to 2 wt % polyvinylalcohol solutions were made by diluting the 10 wt % solution with tap water.

### EXAMPLE 2

### Experiment to Illustrate Erosion/Stripping and Dispersion

To a one litre glass beaker was added 400 ml of a heavy oil and this was followed by addition of 400 ml of a 1 wt % polyvinylalcohol solution prepared as described in Example 1. The arrangement was left at ambient temperature and observed at intervals.

It was observed that, over time, oil at the oil-water interface was gradually stripped therefrom so that it entered the water layer. A sample extracted using a pipette from the water layer into which oil had entered was observed under a microscope and found to comprise very small oil droplets dispersed within the treatment fluid.

### EXAMPLE 3

### Simulation of Recovery of Oil

The objective was to simulate recovery of oil from a subterranean formation using sandpacks and comparing displacement fluids, namely a treatment fluid as described herein and a benchmark brine solution. A temperature controlled sandpack assembly from which oil was to be displaced with selected test fluids using a computer controlled high precision pumping system was used. All displacement tests were conducted at 46° C. Relative efficiencies were estimated from a determination of oil displaced as a function of pore volumes of test fluids injected.

The simulated reservoir properties studied were a temperature of 46° C., a permeability of 2-6 Darcy and a porosity of 35-40%. These conditions were simulated using a sandpack constructed from size sorted glass beads packed in a steel sleeve held at 46° C. in an oven. Potters Ballotini beads were selected. When packed in the apparatus hereinafter described the sandpack porosity was 41%+/−0.5% and the permeability to brine was 3.7 Darcy+/−1 Darcy.

Two test oils were assessed. Test Oil No. 1 had a viscosity of 220 cP at 46° C. and Test Oil No. 2 had a viscosity of 924 cP at 46° C. Water contents of the two oils were found to be less than 0.2%. Prior to use all oils were vacuum filtered through 0.45 μm or 2 μm filters to remove solid particles. Although trace amounts of solids were filtered from all oils, viscosities post-filtering matched those of the oils pre-filtering to within 3%.

One of the displacing fluids assessed was a simulated formation brine which was used as a benchmark fluid. It comprised approximately 50,000 ppm total dissolved solids which was predominantly sodium chloride (about 1 mol·dm⁻³). The viscosity of the brine at 46° C. and a shear rate of 107 s⁻¹ was 0.92 cP, as determined using a Bohlin Gemini 150 rheometer equipped with a double gap concentric cylinder sensor. Prior to use, brine samples were vacuum filtered through a 0.45 μm filter and degassed at 70° C.

The treatment fluid assessed comprised the aforesaid brine containing 0.5 wt % of the poly(vinylalcohol) referred to in Example 1 prepared as described therein. The brine and poly(vinylalcohol) were found to be compatible. The viscosity of the fluid at 46° C. and a shear rate of 105 s⁻¹ was 1.14 cP as determined using a Bohlin Gemini 150 rheometer as previously described.

A schematic representation of the sandpack assembly is provided in FIG. 3. The assembly includes a 12 inch (ca. 30 cm) sandpack 30 packed with beads as described, housed vertically within a laboratory oven (not shown) set at 46° C. A dual ISCO 100DX pump assembly was used to fill the sandpack, and displace fluids from within the sandpack with test fluids, at specified flow rates. One pump 42 was used to inject brine, treatment fluid and solvents for cleaning the system. The second pump 44 was used exclusively to inject filtered crude oil. Both pumps were temperature controlled to provide pre-heating of fluids to reservoir temperature. Displaced effluent fluids were collected in a single collection vessel 52. The assembly includes a two-way diversion valve 46, temperature and pressure gauges 34, 36 and isolation valves 48, 50. All pipework was kept to minimum lengths in order to minimize dead volumes. The full assembly was computer controlled with the ability to continually monitor sandpack temperature, differential pressure and displacement fluid flow rate. Fine manual and automatic control of flow rates was employed in order to maximize reproducibility and reduce errors. Differential pressures, viscosities and flow rates were used to calculate apparent permeabilities using Darcy's law.

The sandpack was prepared by a ‘wet’ packing technique which involved vacuum filling a steel sleeve with a brine based slurry of the Ballotini beads. The mass of beads, to exactly fill the sleeve, was determined using the sandpack volume and the particle density. Sandpack porosities were determined from density corrected weight changes of the sandpack before and after filling. This process ensured brine saturation and reproducibility of sandpack permeabilities, porosities and performance. Once packed with beads the permeability to brine was determined.

After each sandpack had been brine saturated, the brine was displaced by continually flowing oil through the sandpack, using the pumps 44, until no further brine could be displaced. This led to the creation of an oil saturated sandpack at irreducible brine saturation. Once this stage had been reached, permeability to oil was determined, after which point all packs were aged for a minimum of 7 days at 46° C.

The approach taken to assess oil displacement was to displace oil from the oil saturated sandpack, with the treatment fluid or benchmark fluid, until no further oil could be removed. All oil and treatment fluid was collected in a single measuring cylinder and the entire mass of displaced oil determined thermogravimetrically, taking into account potential losses in the pipework. This allowed the percentage oil remaining in the sandpack to be determined by mass balance.

The actual procedure used involved two forms of tests. First, oil was displaced using the benchmark brine until no further oil could be removed, after which point the brine was replaced with the treatment fluid and injection resumed. Effluent was monitored in order to assess the ability to displace further oil with the treatment fluid (post brine displacement testing). A second set of tests involved eliminating the brine displacement phase and injecting the treatment fluid from time zero (time zero testing).

A schedule for the post-brine displacement test was as follows:

(i) Prepare an oil saturated sandpack;
(ii) Displace oil with the brine benchmark fluid until no further oil is displaced
a. Displacement rate: 0.75 ml/minute
b. Monitor differential pressure continually
c. Record the number of pore volumes at which no further oil is displaced
   (iii) Continue injecting the benchmark fluid at 0.75 ml/minute until a total of 15 pore volumes have been injected to ensure no more oil is removed.
   (iv) Increase the injection rate to 5 ml/minute for one further pore volume to ensure that no further oil can be produced.
a. Determine the amount of oil displaced from the effluent analysis and confirm that no more oil can be produced.
   (v) Replace the benchmark fluid with the treatment fluid and continue injection for 15 pore volumes
a. Displacement rate: 0.75 ml/minute
b. Monitor differential pressure continually
c. Record the number of pore volumes at which no further oil is displaced
d. Determine the amount of oil displaced from the effluent analysis.

The above post brine displacement testing schedule was completed for Oil No. 1 in duplicate and Oil No. 2 in triplicate. The time zero test, essentially only stage (v), was completed for Oil No. 1.

### Results

Results for tests undertaken on Test Oils No. 1 and 2 are provided in Tables 1 to 4. All oil percentages refer to original oil in place (OIP). For the post brine displacement tests (Tables 1 and 2), the tables show the amount of oil displaced with 5 pore volumes (PV's) of the benchmark brine. This data may be compared with the extra oil displaced after the injection of ˜15 PV's of the treatment fluid. For both Oil No. 1 and Oil No. 2, the 5 PV brine data is shown since no further oil could be produced by displacement with brine beyond this injected volume.

For the time zero testing, where the benchmark fluid was not used, the oil displaced by 1 PV of the treatment fluid is presented. The 1 PV data is shown since over 90% of the total oil produced was produced within this injection volume. Displacement continued beyond the 1 PV stage and data is presented for the extra amount of oil produced at the 15 PV stage.

TABLE 1
Post brine displacement of Oil No. 1

| | Sandpack | | Benchmark | | Test Fluid | |
|---|---|---|---|---|---|---|
| | Properties | | Fluid 5 PV | | 15 PV | |
| | Aging | Initial | Oil | | Oil | |
| | Time | Oil | Displaced | % OIP | Displaced | % OIP |
| Oil | days | ml | ml | removed | ml | removed |
| No. 1 | 7 | 59 | 31.5 | 53.4 | 8.8 | 14.9 |
| No. 1 | 10 | 58 | 36.1 | 62.2 | 6.3 | 10.9 |
| Average | 8.5 | 58.5 | 33.8 | 57.8 | 7.6 | 12.9 |

It is clear from Table 1 that the treatment fluid displaces extra oil, beyond that removed with brine alone. The interesting observation was that the extra 12.9% oil produced by the treatment fluid was displaced gradually and continuously over the 15 PV's of treatment fluid injected. Indeed, oil production never actually stopped with treatment fluid injection, and traces of oil were still being displaced at 15 PV's when the test was stopped.

TABLE 2
Post-brine displacement of Oil No. 2

| | Sandpack | | Benchmark | | Test Fluid | |
|---|---|---|---|---|---|---|
| | Properties | | Fluid 5 PV | | 15 PV | |
| | Aging | Initial | Oil | | Oil | |
| | Time | Oil | Displaced | % OIP | Displaced | % OIP |
| Oil | days | ml | ml | removed | ml | removed |
| No. 2 | 7 | 61.5 | 25.2 | 41.0 | 5.5 | 9.0 |
| No. 2 | 18 | 57 | 27.9 | 48.9 | 6.3 | 11.0 |
| No. 2 | 19 | 60 | 24.9 | 41.5 | 6.5 | 10.8 |
| Average | 14.7 | 59.5 | 26.0 | 43.8 | 6.1 | 10.3 |

It will be noted from Table 2 that displacement data for Oil No. 2 is similar to that for Oil No. 1, although a slightly lower level of Oil No. 2 is displaced with brine compared with Oil No. 1, 26% c.f. 33.8%. An extra 10% of Oil No. 2 can be displaced with the treatment fluid. As with the Oil No. 1, production never actually stopped during displacement with treatment fluid.

TABLE 3
Oil Displacement - Time zero displacement of Oil No. 1

| | Sandpack | | Test Fluid | | Test Fluid | |
|---|---|---|---|---|---|---|
| | Properties | | 1 PV | | 15 PV | |
| | Aging | Initial | Oil | | Oil | |
| | Time | Oil | Displaced | % OIP | Displaced | % OIP |
| Oil | days | ml | ml | removed | ml | removed |
| No. 1 | 13 | 56 | 32.0 | 57.1 | 4.0 | 7.1 |
| No. 1 | 16 | 56 | 25.4 | 45.4 | 3.2 | 5.7 |
| Average | 14.5 | 56.0 | 28.7 | 51.3 | 3.6 | 6.4 |

A major feature of the time zero data for Oil No. 1 (Table 3) is that a similar proportion of oil is displaced with treatment fluid as is displaced with brine alone in the post brine displacement test, i.e. >51% (see Table 1). However, with the treatment fluid, only 1 PV of displacing fluid is required to displace the amount as compared with ˜5 PV's for the benchmark brine. Speculatively, this may be attributed to the increased surface tension reducing properties of the treatment fluid compared to that of the brine. It is unlikely to be a function of the increased viscosity contrast between the oil and treatment fluid, since the viscosity of the treatment fluid is only marginally higher than that of the benchmark brine.

In the time zero test, further volumes of treatment fluid were injected, beyond the 1 PV needed to extract 51% of the oil. As with the post brine displacement test, more oil was slowly leached out of the sandpack with increasing injection.

The data suggests a substantial increase in displacement efficiency if the treatment fluid is used from time zero.

Thus, in conclusion, an increase in total oil production may be achieved if the treatment fluid (made up in brine) is used to displace oil, post brine flooding. In the tests reported this increase was up to 11% of OIP.

Additionally, an increase in the rate of oil production, as compared to that expected for a brine flooding, may be achieved if the treatment fluid is used. In the tests reported here this rate increase was a factor of five, implying the potential to reduce the required volume of displacing fluid substantially.

Referring to FIGS. 4 to 7, a formulation as described herein may be injected into various injection well types. For example it may be injected into a vertical 100, deviated 102 or horizontal 104 well type. The formulation may be used to increase oil production via various production well types, such as vertical 100, deviated 102, horizontal 104, multilateral 106 and branched wells 108.

The formulation may be used in oil recovery involving the combinations of production and injection wells in the matrix below.

Producer

| | Vertical | | | |
|---|---|---|---|---|
| | and or | | Multi- | |
| | Deviated | Horizontal | lateral | Branched |
| Injector | wells | Wells | wells | wells |
| Vertical | ✓ | ✓ | ✓ | ✓ |
| and or | | | | |
| Deviated | | | | |
| wells | | | | |
| Horizontal | ✓ | ✓ | ✓ | ✓ |
| Wells | | | | |

Examples of such combinations are illustrated in FIGS. 8 to 10. FIG. 8 illustrates flow between a vertical injector 100a and a vertical producer 100b; FIG. 9 illustrates flow between a horizontal injection 104a and horizontal producer 104b; and FIG. 10 illustrates flow between a vertical injector 100 and a horizontal producer 104.

A formulation as described herein may be injected into a well at ambient temperature or at an elevated temperature. A formulation as described may be used in conjunction with other fluids and/or treatments. For example, recovery of heavy oil may involve sequential injection of a formulation (e.g. treatment fluid) as described and steam or miscible gases. Referring to FIGS. 11 to 15, the following technique are exemplified:

FIG. 11—heated treatment fluid may be injected into injector 120 and oil recovered from producer 130. Alternatively, the treatment fluid may be injected at its ambient temperature.

FIG. 12—in a first step heated treatment fluid may be injected as in the FIG. 11 embodiment; such injection is then stopped and is followed by steam injection. Treatment fluid and/or steam may then be alternately injected. As an alternative, instead of steam, miscible gases may be injected alternately with the treatment fluid.

As an alternative to using a treatment fluid consisting essentially of poly(vinylalcohol) in water as described in Example 1 the fluid may include one or more of the following additional additives, as follows:

(a) Water-soluble silicates—suitably, these may be alkali metal silicates (e.g. mixed sodium/potassium silicates; or sodium silicate and/or potassium silicate) selected to have a basic pH (e.g. 9 to 11) when in solution. The M₂O to SiO₂ ratio (where M is a metal) may be greater than 2.0. The concentration of silicate may be up to 2 wt %. The silicate may have two functions: as a buffer, maintaining a constant high pH level to produce a minimum interfacial tension value; and improving efficiency of the poly(vinylalcohol) by removing hardness ions from reservoir brines, thus reducing the adsorption of the poly(vinylalcohol) on rock surfaces.
(b) Nano-particles—insoluble nano-particles having rigid structures. Such particle will suitably be silicon based and may be insoluble silicates. The inclusion of nano-particles in the formulation is to create particle induced turbulence to aid both mixing and movement through the porous medium of oil stabilised by the treatment fluid, without blocking pores of the porous medium. The nano particles may also effect heat transfer intensification.
(c) Water soluble gases—by dissolving a gas in the treatment fluid an energised fluid may be produced. Carbon dioxide or nitrogen may be suitable gases. The use of such gases may lead to an enhanced, transportation mechanism by facilitating mixing and/or swelling and enhancing viscosity reduction.
(d) pH modifiers=these may be used to adjust pH to optimise the pH for the poly(vinylalcohol) to achieve its desired effect.
(e) surfactants—these may be used to act in conjunction with the poly(vinylalcohol)

In some embodiment, foams may intentionally be created which may be used to block high permeability regions of the subterranean formation and enhance conformance sweep.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of recovering oil from a subterranean formation which includes an associated production well, the method including the steps of:
(i) contacting oil in said formation with a treatment fluid formulation at a position upstream of said production well, wherein said treatment fluid formulation comprises a polymeric material AA which includes —O— moieties pendent from a polymeric backbone thereof; and
(ii) collecting oil which has been contacted with said treatment fluid formulation via said production well.

2. A method according to claim 1, wherein said oil is trapped in pores or other hollow regions and separated from other oil trapped in pores or other hollow regions.

3. A method according to claim 1, wherein initial contact of oil in said formation with said treatment fluid formulation takes place at a position which at least 5 metres upstream of said production well.

4. A method according to claim 1, wherein said subterranean formation which comprises oil to be recovered is a naturally occurring porous medium.

5. A method according to claim 1, wherein said formation has a permeability of less than 20 Darcy.

6. A method according to claim 1, wherein before contact with said treatment fluid formulation the oil in said formation has a viscosity of at least 100 cp when measured at the reservoir temperature of the oil and at a sheer rate of 100 s⁻¹.

7. A method according to claim 1, wherein the ratio of the temperature of the treatment fluid formulation immediately prior to introduction compared to the reservoir temperature at the position of introduction is at least 0.5.

8. A method according to claim 1, wherein said treatment fluid formulation is introduced into the formation at a rate of at least 0.5 l·s⁻¹.

9. A method according to claim 1, wherein the treatment fluid formulation is introduced into the formation substantially continuously over a period of at least 1 hour.

10. A method according to claim 1, wherein the method comprises introducing said treatment fluid formulation into said formation via an injection well.

11. A method according to claim 1, wherein the treatment fluid is arranged to carry oil towards the production well.

12. A method according to claim 1, wherein the material collected in step (ii) comprises less than 1 wt % of said polymeric material AA.

13. A method according to claim 1, wherein the material collected in step (ii) comprises greater than 30 wt % of water.

14. A method according to claim 1, wherein said treatment fluid formulation has a viscosity at 25° C. and 100 s⁻¹ of greater than 0.5 cP and of not greater than 10 cP.

15. A method according to claim 1, wherein said treatment fluid formulation includes at least 70 wt % and less than 99.6 wt % water.

16. A method according to claim 1, wherein said treatment fluid formulation includes at least 0.2 wt % and less than 5 wt % of said polymeric material AA.

17. A method according to claim 1, wherein the total amount of active materials in said treatment fluid formulation is at least 0.2 wt % and is less than 3 wt %.

18. A method according to claim 1, wherein said polymeric material AA makes up at least 90 wt % of active materials in said treatment fluid formulation.

19. A method according to claim 1, wherein said polymeric material AA includes a moiety

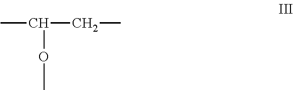

20. A method according to claim 1, wherein the ratio of the number of acetate groups to the number of hydroxyl groups in said polymeric material AA is in the range 0.1 to 2.

21. A method according to claim 1, wherein said polymeric material AA comprises 60 to 95% hydrolysed polyvinyl acetate.

22. A method according to claim 1, wherein said polymeric material AA is a polyvinyl alcohol polymer or copolymer.

23. A method according to claim 1, wherein said treatment fluid formulation includes one or more additional materials arranged to be surface active, affect the pH of the formulation or which comprise an insoluble particle arranged to increase turbulence within the treatment fluid formulation.

24. A method according to claim 23, where a said additional material comprises nanoparticles.

25. The use of a treatment fluid formulation for improving the mobility of oil in a subterranean formation at a position upstream of a production well associated with the formation to facilitate flow of oil from the formation into the production well, wherein said treatment fluid formulation comprises a polymeric material AA which includes —O— moieties pendent from a polymeric backbone thereof.

26. A subterranean formation which includes an associated production well, the subterranean formation including a treatment fluid formulation at a position upstream of the production well, said treatment fluid formulation comprising a polymeric material AA which includes —O— moieties pendent from a polymeric backbone thereof.

27. A subterranean formation according to claim 24, which includes said treatment fluid formulation at a position downstream of an injection well of the subterranean formation.
